(19) United States
(12) Patent Application Publication
(10) Pub. No.: US 2016/0325579 A1
(43) Pub. Date: Nov. 10, 2016

(54) SILK FIBROIN SECURITY FIBERS CONTAINING SECURITY MARKERS AND A PROCESS FOR THE PREPARATION THEREOF

(71) Applicant: COUNCIL OF SCIENTIFIC & INDUSTRIAL RESEARCH, Rafi Marg, New Delhi (IN)

(72) Inventors: Ashwinikumar Ramesh Sharma, Pune (IN); Premnath Venugopalan, Pune (IN); Sangeeta Sunil Hambir, Pune (IN)

(21) Appl. No.: 15/109,544

(22) PCT Filed: Jan. 5, 2015
(86) PCT No.: PCT/IN2015/000003

§ 371 Date: Jul. 1, 2016

(30) Foreign Application Priority Data
Jan. 3, 2014 (IN) 0016/DEL/2014

(51) Int. Cl. B42D 25/355; D01F 1/04; D01F 4/02; D01D 5/06; B42D 25/29; C09K 11/77; C09K 11/06; B42D 25/382; B42D 25/387; B42D 25/24; D01F 1/06; D01D 1/02

(52) U.S. Cl. CPC B42D 25/355; D01F 1/06; D01F 1/04; D01F 4/02; D01D 5/06; D01D 1/02; C09K 11/7774; C09K 11/06; B42D 25/382; B42D 25/387; B42D 25/24; B42D 25/29; C09K 2211/1014; C09K 2211/1007

(57) ABSTRACT

Present invention discloses loaded silk fibroin fibers as security features. Particularly, it provides security fiber comprising silk fibroin loaded with fluorescent chromophore or IR absorbing chromophore useful to combat counterfeiting. The invention discloses paper composition containing loaded silk fibroin fibers, provides method for authentication of paper embedded with security features.

### CROSS-REFERENCE TO RELATED APPLICATION(S)

This application is a National Phase Patent Application and claims the priority of International Application Number PCT/IN2015/000003, filed on Jan. 5, 2015, which claims priority to Indian Patent Application No. 0016/DEL/2014, filed Jan. 3, 2014, the entire contents of both which are incorporated herein.

### FIELD OF THE INVENTION

The present invention relates to silk fibroin security fibers containing security markers and a process for the preparation thereof. Particularly the invention relates to a security fiber comprising silk fibroin loaded with inorganic fluorescent chromophore and organic IR absorbing chromophore useful to combat counterfeiting. The invention further relates to paper composition containing said loaded silk fibroin fibers. Further the invention provides method for authentication of paper embedded with said security features.

### BACKGROUND AND PRIOR ART OF THE INVENTION

Security labeling or marking becomes very crucial in modern age to prevent forgery, tampering, and counterfeiting of the items such as banknotes, passports, tamper-evident labels, product authentication, stock certificates, postage stamps and identity cards.

Security features in banknotes can be classified based on location (embedded in the substrate, loaded in the ink, combined with other security features such as security thread) or based on whether it is visible or not (overt or covert).

It is well known that the Indian currency note has microfibers (3 mm in length by tens of microns thick) dispersed in the paper that has bands of UV fluorescent materials that show colors under UV light. The Indian currency note has fibers with bands of red or fibers with bands of green or a physical mix of these fibers.

PCT/EP2010/070172 discloses an encoded object, wherein the object comprising at least one encoded microfiber or nanofiber comprising a polymer and a bleachable fluorophore. The polymer may be any of polystyrene, cellulose-acetate-phthalate or poly (lacticco-glycolic acid), polyethylene glycol, ethyl cellulose, polyethylene oxide, wherein fluorophore is coumarin-6 or fluorescein, further the use of an encoded object as described above for preventing counterfeiting of objects, such as food, drugs, etc.

Silk and other fibers have been commonly used in the manufacture of various banknote papers, intended to provide both additional durability and security.

Surface modification and functionalization of silk fibroin fibers/fabric towards high performance textile and biomaterial applications is reported by Guohong Lia et al., in Materials Science and Engineering: C in 32, (4), 2012, pg 627-636.

‘U.S. Pat. No. 7,662,873’ discloses the preparation of fibrous substrates, including textiles, marked with colloidal particle nanobar codes, to the fibrous substrates so prepared, and to methods for detecting the nanobar codes on the fibrous substrates for use in quality control, counterfeiting, and the like. The fibrous substrates of said invention are intended to include fibers, fabrics and textiles, and sheet-like structures (Woven, knitted, tufted, stitch-bonded, or non-Woven) comprised of fibers or structural elements, such as natural fibers which include cotton, wool, silk, jute, and linen.

‘U.S. Pat. No. 307,956’ disclose manufacturing of paper for bank-notes from palmetto or other long fiber combined with asbestos, wherein the paper for banknotes or other securities containing fibers of colored silk, to indicate the value or origin of the document.

Further CN103103890 discloses a security paper comprises at least two layers of independently molded paper pages, wherein ‘fiber textile belt’ is arranged between the two paper pages and provided with a security element; the fiber textile belt comprises a silk screen layer woven from a hot melting material with melting point at 50-100° C.

The Korean publication KR20090063711 discloses a security paper containing silk fiber and a method for discriminating the same, wherein the length of silk fiber ranges from 0.3 to 1.0 mm. The content of the silk fiber is 5-30 weight % based on the whole content of the security paper. The authenticity of the said security paper uses microscopic observation.

It is observed that the microfiber currently in the banknote are surface treated, where the fluorescent dye is attached to the surface of the microfiber, hence there are chances to lose the fluorescence over a period of time, thereby fails in authentication and results in rejection of the note.

Further the reported microfiber or nanofiber containing polymers preferably hydrophobic polymer, wherein the dye loading into fiber as bulk mixture or extruded fiber into an aqueous pulp solution is difficult.

In view of the above shortcomings, there was a need to provide security features that can introduce considerable difficulty for forgers in replicating the technology. In this context, substrate embedded features are highly desirable.

Chinese patent CN102061097 which discloses two-photon fluorescence biological material wherein the two photon fluorescence material is evenly compounded in silk fibre or treated silk fiber. The composite material shows excitation in the near infra-red region (780-1300 nm), less than the wavelength of the fluorescence excitation wavelength (600_1300 nm). The two-photon organic fluorescent material is selected from stilbene derivatives, azo derivatives, thiophene derivatives, fluorenone derivatives, carbazole derivatives, anthracene derivatives or pyridine derivatives and the like. Particularly, the organic absorber is selected from 2,7-dinitrobenzene vinyl-9,9′-dibutyl fluorene, 2,7-nitrostyryl-9,9′-two octyl fluorene, 2,7-dibromo-9,9-dibutyl-fluorene alone or in combination thereof.

With continuing need for novel security features in the growing scenario of counterfeiting the present invention provides an alternate security feature to the existing art.

Further, the present invention lay emphasis on loading the microfiber in bulk rather than being limited to surface modifications, which lower the risk of loss of markers when exposed to chemicals or other stimuli, and also making it impossible for the frauders to replicate the technology.

Further, the use of crystal lattices doped with rare earth ions is known in the art (WO2009/136921). These compounds may absorb radiation at one frequency, and emit radiation at a different frequency, wherein radiation refers to UV, visible, near infrared and infrared radiation. When irradiated with a given wavelength of radiation, these compounds luminesce at a second wavelength and such luminescence may be detected by a detector. Such luminescent compounds are called “luminophores” which may be ions or compounds. Further, IR fluorescent dyes having absorption and emission in near infra-red region (NIR) are used for in vivo imaging due to narrow emission spectra of the dyes and no crossover between fluorophores.

Since the inorganic lattices doped with rare earth elements show spectral characteristic to ions, making it difficult for the forgers to reverse the technology, the present invention use this potential feature to develop novel security silk fiber to combat counterfeiting.

### OBJECTS OF THE INVENTION

The main objective of the present invention is to provide silk fibroin security fibers containing security markers and a process for the preparation thereof.

Another objective of the present invention to provide security element using luminophores selected from inorganic crystal lattices doped with rare earth elements or IR absorbers loaded in the silk fibroin to combat counterfeiting.

Another objective of the present invention is to provide the security element that can be mixed with cotton pulp for making security paper.

### SUMMARY OF THE INVENTION

Accordingly, the present invention provides a security fiber comprising silk fibroin loaded with markers selected from inorganic UV fluorescent chromophore and/or organic IR absorbing chromophore that is identified on exposure to said spectral wavelength, wherein said security fiber is useful to combat counterfeiting.

In an embodiment of the present invention the UV fluorescent chromophore is selected from inorganic material preferably Sodium yttrium Fluoride-oxide doped with Ytterbium and Thalium.

In one embodiment of the present invention the IR absorbing chromophore is selected from organic dye such as Dimethyl{4-[1,7,7-tris(4-dimethylaminophenyl)-2,4,6-heptatrienylidene]-2,5-cyclohexadien-1-ylidene}ammonium perchlorate

In another embodiment of the present invention the silk fibroin is selected from natural silk fiber or regenerated silk fiber.

In another embodiment of the present invention the markers are loaded in the silk fibroin in the ratio ranging between 0.09-0.1 wt %.

Still in another embodiment of the present invention the fibers are micron size, in the range of 10 microns to 200 microns and thickness of the fibers is in the range of 50 microns to 150 microns.

Still in another embodiment of the present invention a substrate was embedded with security fiber which can be identified on exposure to said spectral wavelength.

Still in another embodiment of the present invention the substrate is selected from textiles, fabrics, plastics, security paper such as bank note paper, passport paper, visa paper, fiduciary paper or labels, packaging materials and the like.

Still in another embodiment of the present invention authentication of substrate embedded with security fiber comprising the loaded markers using UV light or IR light was carried out by irradiating and observing the reflected light from the surface of the substrate.

Still in another embodiment of the present invention the process the preparation of security fiber, wherein said process comprising;
i. dissolving lyophilized silk or regenerated silk fibroin in HFIP to obtain a solution in the concentration range of 3 to 12 wt;
ii. mixing the markers in to the silk solution of step (1), wherein the concentration of fluorescent marker varies from 0.1 to 10.0 w/v % depending upon the concentration of silk solution;
iii. Spinning the mixed solution and extruding the filament into the methanol coagulation bath at room temperature followed by soaking the filament in methanol to obtain the loaded security fiber free of HFIP.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 depicts process of making Silk fiber/IR absorbing fiber/UV fluorescence fiber through extrusion.

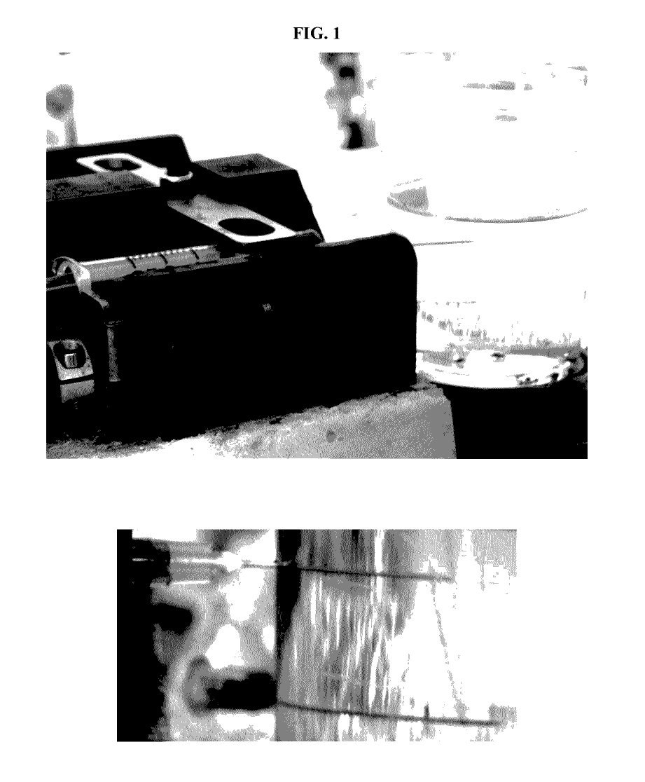

FIG. 2 depicts obtained strands of UV fluorescent silk fibers chopped in 3-5 mm length.

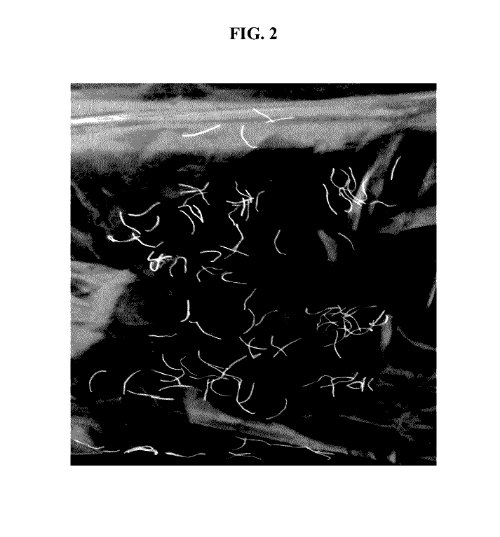

FIG. 3 depicts optical image determining thickness of 150 microns for UV fluorescent silk fibers at the speed of 0.3 ml/min.

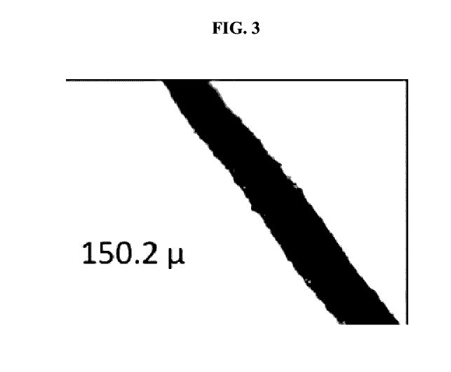

FIG. 4 depicts cotton paper embedded with UV fluorescent silk fibers in visible light.

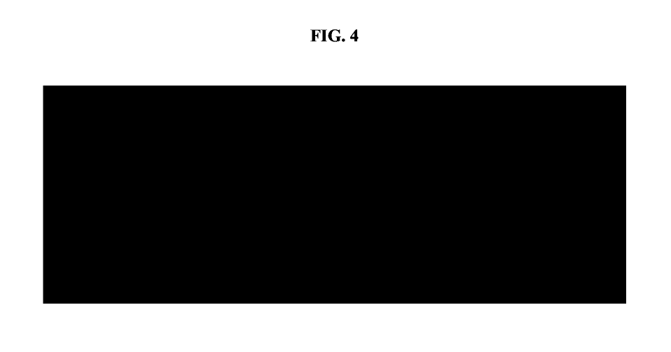

FIG. 5 depicts authentication of paper embedded with UV fluorescence [Sodium yttrium Fluoride-oxide doped with Ytterbium and Thalium (Na, Y, Yb, Tm) F4 material] silk fibers with human eye. Right side image shows Yellow-Red fluorescence at 365 nm; whereas image to the left show Orange-Red fluorescence under UV lamp (254 nm).

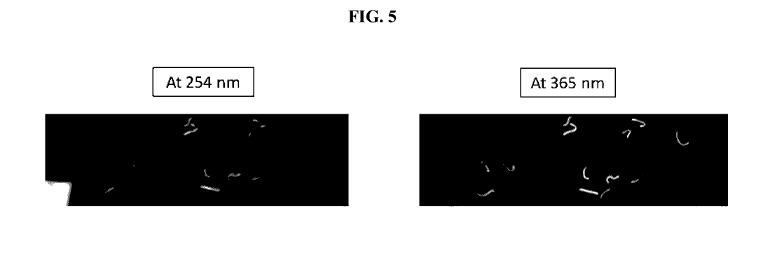

FIG. 6 depicts obtained strands of NIR absorbing silk fibers chopped in 3-5 mm length.

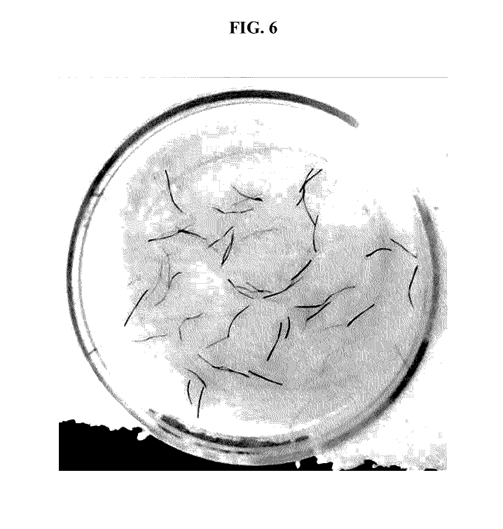

FIG. 7 depicts optical image determining thickness of IR absorbing silk fibers at two different injections Speed. At speed of 0.05 ml/min fibers has thickness between 45-50 microns and at 0.1 ml/min fibers has thickness between 75-85 microns.

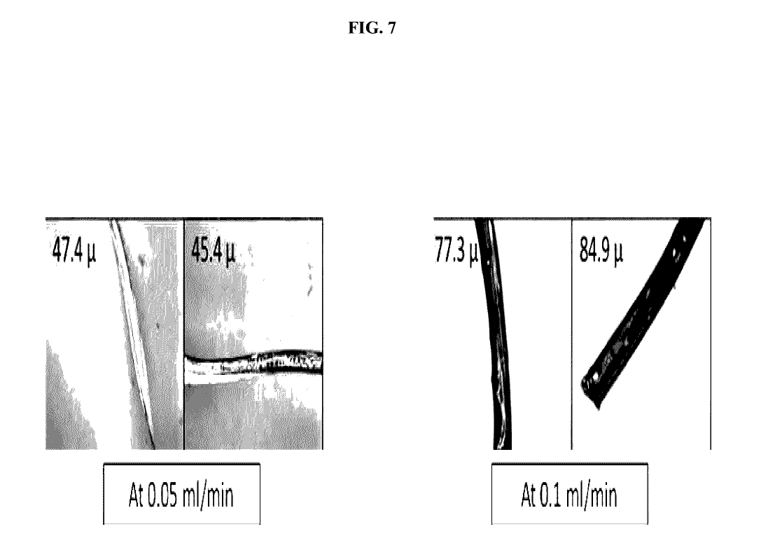

FIG. 8 depicts cotton paper embedded with IR absorbing silk fibers in visible light.

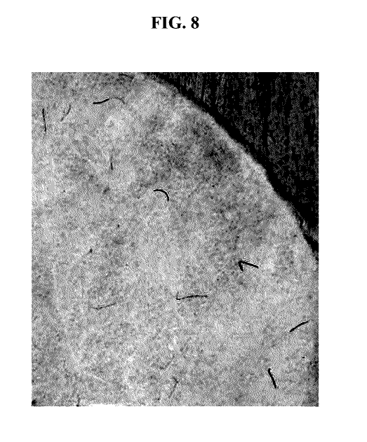

FIG. 9 depicts authentication of paper embedded with IR absorbing (IR-895 dye) silk fibers using a digital camera capable of detecting IR light. Right side image shows blackening of fibers under NIR light as it contains NIR absorbing silk fibers; whereas image to the left does not show any kind of absorbance of NIR light.

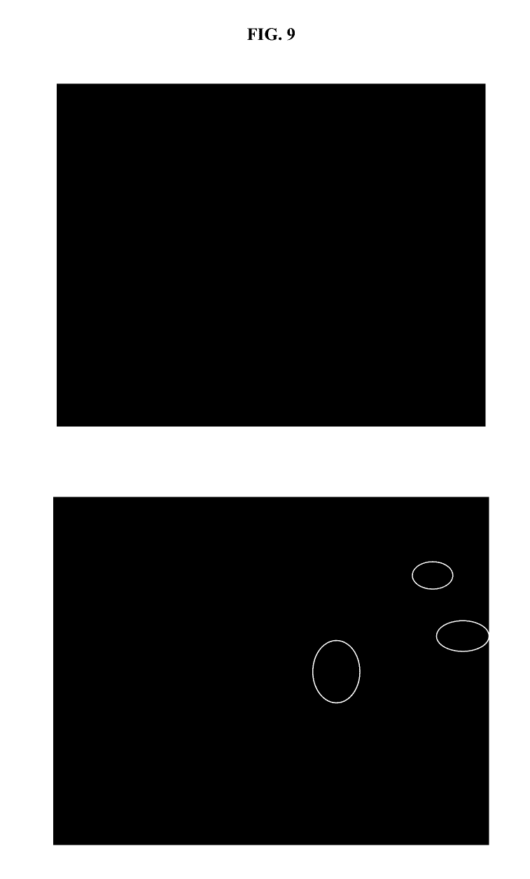

### DETAILED DESCRIPTION OF THE INVENTION

The present invention describes the loaded silk fibroin as security feature in the substrate to combat counterfeiting, wherein said loaded silk fibroin is embedded in to the substrate making it impossible for the frauders to replicate the technology and hence useful in counteracting counterfeiting.

The present invention uses the luminophores and/or the IR fluorescent dyes advantageously as markers to provide security features to combat counterfeiting and prohibiting the replication of technology.

The present invention relates to a security fiber comprising of silk fibroin loaded with markers selected from inorganic UV fluorescent chromophore and organic IR absorbing chromophore that can be identified on exposure to said spectral wavelength, wherein said security fiber is useful to combat counterfeiting.

The UV fluorescence absorber is selected from inorganic material such as Sodium yttrium Fluoride-oxide doped with Ytterbium and Thalium. The NIR absorber is selected from organic dye IR-895, i.e. Dimethyl{4-[1,7,7-tris(4-dimethylaminophenyl)-2,4,6-heptatrienylidene]-2,5-cyclohexadien-1-ylidene}ammonium perchlorate. The silk fiber is selected from natural silk fiber or regenerated silk fiber (RSF), preferably the silk fiber is RSF which imparts durability and toughness to the fiber.

The fluorescent markers used in the present invention are substantially colourless. The UV fluorescent material can be excited at a wavelength 254 nm and 365 nm and IRIR absorber in the wavelength 890 nm. The marker is loaded in to the silk fibroin in the ratio of 0.1 wt/v %. The present invention relates to a process for preparing said security fiber through extrusion, wherein said markers are bulk loaded in to the silk fiber.

The process for bulk loading the markers in to the silk fibroin to obtain security fiber comprises;
1. dissolving lyophilized silk or regenerated silk fibroin in HFIP (Hexafluoro-iso-propanol) to obtain a solution in the concentration range of 3 to 12 wt %.
2. mixing the fluorescent markers in to the silk solution of step (1), wherein the concentration of fluorescent marker varies from 0.1 to 10.0 w/v % depending upon the concentration of silk solution;
3. spinning the mixed solution and extruding the filament into the methanol coagulation bath at room temperature followed by soaking the filament in methanol to obtain the loaded silk fiber, free of HFIP.

The spinning may be carried out by wet spinning or electrospinning technique known in the art.

The loaded silk fibers obtained are nano, milli or micron sized, preferably micro sized depending on the speed of extrusion. The thickness of the fibers is in the range of 10 microns to 200 microns, preferably in the range of 50 microns to 150 microns. Further these fibers were chopped in 3-5 mm length.

The present invention relates to a substrate embedded security fiber wherein said security fiber comprises silk fibroin loaded with markers selected from inorganic UV fluorescent chromophore and organic IR absorbing chromophore useful to combat counterfeiting.

The substrate is selected from the group consisting of textiles, fabrics, plastics and security paper such as bank note paper, passport paper, visa paper, fiduciary paper or labels, packaging materials and the like.

The silk fiber is selected from natural silk fiber or regenerated silk fiber (RSF), preferably the silk fiber is RSF which imparts durability and toughness to the fiber.

In an aspect, the markers are loaded in to the silk fibroin at a ratio of 0.1 w/v % UV fluorescent dye and 5 w/v % IR dye.

In another aspect, the present invention provides a process for preparation of said security fiber through extrusion, wherein said markers are bulk loaded in to the silk fiber. The silk fibers obtained are nano, milli or micron sized, preferably micro sized. The concentration of loading material varies from 0.1 to 10.0 w/v % depending upon the concentration of silk solution.

Optionally, the loaded silk fibers are obtained by electrospinning technique.

The thickness of fibers obtained by the electrospinning or extrusion technique is in the range of 10 microns to 200 microns, preferably 50 microns to 150 microns depending on the speed of extrusion or electrospinning.

In yet another aspect, the present invention provides a substrate embedded security fiber wherein said security fiber comprises silk fibroin loaded with markers selected from UV fluorescent chromophore or IR absorbing chromophore.

The substrate is selected from the group consisting of textiles, fabrics, plastics and security paper such as bank note paper, passport paper, visa paper, fiduciary paper or labels, packaging materials and the like

In an aspect, the present invention relate to a security paper comprising cotton fibers and silk fibroin loaded with markers selected from inorganic UV fluorescent chromophore or organic IR absorbing chromophore; wherein said security feature is embedded in to the security paper.

In another aspect, the present invention provides a process for embedding said security fiber into the paper comprising dissolving said security fiber loaded with markers into the slurry of paper pulp in suitable ratio of 0.15 w % to form a uniform dispersion, setting the dispersion on the mesh and drying the sheet of security paper embedded with silk fiber on the mesh by pressing.

In yet another aspect, the present invention provides a method for authentication of articles/objects using such bulk loaded silk fibers comprising irradiating the security markers using UV light or using a digital camera capable of detecting IR light reflected from the surface of the article/object.

The articles/objects comprises textiles, fabrics, plastics and security paper such as bank note paper, passport paper, visa paper, fiduciary paper or labels, packaging materials and the like.

The present invention relate to a security paper comprising cotton fibers and silk fibroin loaded with markers selected from inorganic UV fluorescent chromophore and organic IR absorbing chromophore; wherein said security feature is embedded in to the security paper.

The present invention relate to a process for embedding the security feature in to the paper comprising; dissolving security fiber loaded with markers of the present invention into the slurry of paper pulp in suitable ratio of 0.15 wt % to form a uniform dispersion, settling the dispersion on the mesh and press drying the sheet of security paper embedded with silk fiber on the mesh. Accordingly the process of loading the marker in to the silk fibroin to obtain loaded silk fibre as security element and further embedding said security element in to the paper is described herein below:

The preparation of RSF (Regenerated Silk Fibroin) solution in water or aqueous RSF solution is known in the literature [Express polymer letters 2, (12), 2008, pg 885-889], wherein Bombyx mori cocoons (procured from Central Sericultural Research & Training Institute, Sriramapura, Mysore, Karnataka) were degummed, then the degummed silk fiber was dissolved in LiBr solution to high concentration at 40° C. and then dialyzed against deionized water. Further the lyophilized silk sponge was dissolved in HFIP (Hexafluoro-iso-propanol) for 2 days, to yield RSF solution.

The obtained RSF solution is then mixed with loading material, such as IR absorbing dye, UV fluorescent chromophore, wherein the concentration of loading material varies from 0.1 to 10.0 w/v % depending upon the concentration of RSF solution. The material is loaded in the bulk of the fiber (not on surface only), the ‘loaded silk microfibers’ is further extruded through a stainless steel spinneret with 0.45 mm inner diameter using syringe pump into the methanol coagulation bath at room temperature or the ‘loaded silk microfibers’ are drawn using electrospinning technique.

The extruded filament is then soaked in the methanol bath over 3 h to allow the HFIP to diffuse from the fiber. The thickness of fibers obtained by the electrospinning or extrusion technique is in the range of 10 microns to 200 microns, preferably 50 microns to 150 microns depending on the speed of extrusion or electrospinning.

Further the ‘loaded silk microfibers’ are collected and chopped in 3-5 mm length.

In the next step, the chopped, ‘loaded silk microfibers’ are mixed with the paper pulp, in the suitable ratio of 0.15 w t% i.e. 6-8 fibers in the pulp required to make 50×50 mm² papers. The loaded silk fiber shows uniform dispersion with cotton fibers. The preparation of paper pulp from cotton fibers in water is as reported in the art.

Thus, the paper embedded with security feature is obtained, wherein the surface feature is UV or IR absorbing dye' loaded silk fibroin microfibers', particularly the security paper made by the instant process comprises, mixture of cotton fiber and UV fluorescent chromophore loaded silk microfibers; or cotton fiber and IR absorbing chromophore loaded silk microfibers.

The invention provides a method for authentication of article/ object embedded with security fiber comprising irradiating the loaded markers using UV light or IR light and observing the reflected light from the surface of the article/object.

The articles/objects can be selected from textiles, fabrics, plastics, security paper such as bank note paper, passport paper, visa paper, fiduciary paper or labels, packaging materials and the like.

Accordingly, the authentication of paper embedded with UV fluorescent silk microfibers is irradiated using UV vapor lamp or other UV source and observing the colour change. Silk Fibers loaded with UV fluorescent chromophore shows Orange-Red color fluorescence which can be easily detected by human eye.

Similarly, the authentication of paper embedded with IR absorbing silk fibers is performed by irradiating said absorber with IR light. Silk Fibers loaded with IR absorbing chromophore shows black colour of fibers due to absorbance which can be easily detected using a digital camera capable of detecting IR light reflected from the surface of the paper.

The present invention relates to the use of security fiber comprising silk fibroin loaded with markers selected from inorganic UV fluorescent chromophore or organic IR absorbing chromophore which can be identified on exposure to said wavelength for authentication of articles/objects.

### EXAMPLES

The following examples are given by way of illustration of the working of the invention in actual practice and should not be construed to limit the scope of the present invention in any way.

### Example 1

Preparation of Silk Fibers Using Regenerated Silk Fibers in Hexafluoro-iso-propanol (HFIP) Through Extrusion Method

The lyophilized silk sponge was dissolved in HFIP for 2 days, yielding a 12 w/v % solution. The HFIP solution was extruded through a stainless steel spinneret with 0.45 mm inner diameter using syringe pump into the methanol coagulation bath at room temperature (25° C.). The extruded filament was soaked in the methanol bath over 3 h to allow the HFIP to diffuse from the fiber. The obtained fibers were 45-50 microns in thickness. Fibers were cut with the scissor in a fixed length of 3-5 mm approximately.

### Example 2

Preparation of Silk Fibers Using Regenerated Silk in Hexafluoro-iso-propanol (HFIP) Through Electrospinning

The lyophilized silk sponge was dissolved in HFIP for 2 days, yielding a 12 w/v % solution. The HFIP solution was electrospun through an Electrospinning instrument consisting of stainless steel spinneret with 0.45 mm inner diameter, syringe pump and collector plate at room temperature (25° C.). Thickness of the obtained fibers was found 100 nm-1 micron. Further depending on the rate of infuse volume and spinneret inner diameter, fibers upto 30-35 microns were obtained. Obtained nano and micron size fibers were chopped in 3-5 mm length as given in example 1.

### Example 3

Preparation of Silk Fibers Loaded with UV Fluorescent Chromophore

90 mg of lyophilized silk sponge was dissolved in 3 ml HFIP for 2 days, in order to get 3 w/v % of silk solution. This is followed by mixing 0.15 mg (5 w/v %) of Sodium yttrium Fluoride-oxide doped with Ytterbium and Thalium (Na, Y, Yb, Tm) F4 (UV fluorescent material, obtained from Global Nanotech, Catalouge no. For UV fluroscent dye, sodium yttriium fluroide-oxide doped with yttrium & thalium purchased from Global Nanotech, Mumbai is IOVV200) with 3 ml of 3 w/v % silk solution. A well dispersed UV fluorescent material silk solution was obtained. This obtained silk solution was extruded through a stainless steel spinneret with 0.45 mm inner diameter using syringe pump into the methanol coagulation bath at room temperature (25° C.). The speed of extrusion was maintained at 0.3 ml/min. The extruded filament was soaked in the methanol bath over 3 h to allow the HFIP to diffuse from the fiber. The fibers were obtained with 150 microns thickness. Thickness measurement was done using optical microscope. The fibers were chopped in 3-5 mm length as given in example 1.

### Example 4

Preparation of Silk Fibers Loaded with IR Absorbing Chromophore

90 mg of lyophilized silk sponge was dissolved in 3 ml HFIP for 2 days, in order to get 3 w/v % of silk solution. 0.003 mg i.e. (0.1 w/v %) of Dimethyl{4-[1,7,7-tris(4-dimethylaminophenyl)-2,4,6-heptatrienylidene]-2,5-cyclohexadien-1-ylidene}ammonium perchlorate (IR-895 dye sigma made) was mixed with 3 ml of 3 w/v % silk solution. A well dispersed IR-895 dye silk solution was obtained. This obtained silk solution was extruded through a stainless steel spinneret with 0.45 mm inner diameter using syringe pump into the methanol coagulation bath at room temperature (25° C.). The speed of extrusion was maintained at 0.3 ml/min. The extruded filament was soaked in the methanol bath over 3 h to allow the HFIP to diffuse from the fiber. The fibers obtained with 50 microns thickness. Thickness measurement was done using optical microscope. The fibers were chopped in 3-5 mm length as given in example 1.

### Example 5

Preparation of Paper with Cotton Fibers

10 μm of cotton rags were taken and chopped in length of 0.5 to 1 mm. Chopped cotton rags were then digested in H₂O₂ and 1% aqueous solution of NaOH and at 90° C. with constant stirring for 1 hr. Further digested cotton rags were washed with water, to remove excess NaOH and H₂O₂ The cotton rags were ball milled to form the cotton rag pulp for 15 minutes. Obtained pulp was dispersed in 1000 ml distilled water to form slurry. Finally paper was made, by settling of cotton rags slurry uniformly on the mesh and press drying the sheet of fibers on mesh.

### Example 6

Preparation of Paper with Mixture of Cotton Fiber, UV Fluorescent Chromophore Fibers and Authentication in UV Light.

The silk fibers obtained from example 3, were mixed with the paper pulp, in the ratio 0.15 wt % i.e. 6-8 fibers in the pulp required to make 50×50 mm² papers. UV fluorescent silk fiber showed uniform dispersion with cotton fibers. Further the paper was made from the pulp as explained in example 5. Authentication of paper embedded with UV fluorescent silk fibers was done by observing the paper under UV lamp. Silk Fibers loaded with UV fluorescent chromophore showed Orange-Red color fluorescence which can be easily detected by human eye.

### Example 7

Preparation of Paper with Mixture of Cotton Fiber, IR Absorbing Chromophore Fibers and Authentication in IR Light

The silk fibers obtained from example 4 were mixed with the paper pulp, in the suitable ratio of 0.15 wt % i.e. 6-8 fibers in the pulp required to make 50×50 mm² papers. IR absorbing silk fiber showed uniform dispersion with cotton fibers. Further the paper was made from the pulp as explained in example 5. Authentication of paper embedded with IR absorbing silk fibers was done by observing the paper under IR light. Silk Fibers loaded with IR absorbing chromophore showed black colour of fibers due to absorbance, hence can be easily detected using a digital camera capable of detecting IR light reflected from the surface of the paper.

### Advantages of Invention

The instant microfiber is made of silk fibroin, makes the current invention cost effective, also the said invisible markers are bulk loaded in the microfiber (not merely surface treated), which minimizes loss of fluorescence, lowers the risk of loss of security markers when substrate is exposed to chemical, solvent or other stimuli. Further, the invention provides novel security element that prohibits the forgers form replicating the technology.

1. A security fiber comprising silk fibroin loaded with markers selected from inorganic UV fluorescent chromophore and/or organic IR absorbing chromophore that is identified on exposure to said spectral wavelength, wherein said security fiber is useful to combat counterfeiting.

2. The security fiber according to claim 1, wherein the UV fluorescent chromophore is selected from inorganic material preferably Sodium yttrium Fluoride-oxide doped with Ytterbium and Thalium.

3. The security fiber according to claim 1, wherein the IR absorbing chromophore is selected from organic dye such as Dimethyl{4-[1,7,7-tris(4-dimethylaminophenyl)-2,4,6-heptatrienylidene]-2,5-cyclohexadien-1-ylidene}ammonium perchlorate

4. The security fiber according to claim 1, wherein the silk fibroin is selected from natural silk fiber or regenerated silk fiber.

5. The security fiber according to claim 1, wherein the markers are loaded in the silk fibroin in the ratio ranging between 0.09-0.1 wt %.

6. The security fiber according to claim 1, wherein the fibers are micron size, in the range of 10 microns to 200 microns and thickness of the fibers is in the range of 50 microns to 150 microns.

7. The security fiber according to claim 1, wherein a substrate was embedded with security fiber which can be identified on exposure to said spectral wavelength.

8. The security fiber according to claim 7, wherein the substrate is selected from textiles, fabrics, plastics, security paper such as bank note paper, passport paper, visa paper, fiduciary paper or labels, packaging materials and the like.

9. The security fiber according to claim 1, wherein authentication of substrate embedded with security fiber comprising the loaded markers using UV light or IR light was carried out by irradiating and observing the reflected light from the surface of the substrate.

10. The process the preparation of security fiber as claimed in claim 1, wherein said process comprising;
i. dissolving lyophilized silk or regenerated silk fibroin in HFIP to obtain a solution in the concentration range of 3 to 12 wt;
ii. mixing the markers in to the silk solution of step (1), wherein the concentration of fluorescent marker varies from 0.1 to 10.0 w/v % depending upon the concentration of silk solution;
iii. Spinning the mixed solution and extruding the filament into the methanol coagulation bath at room temperature followed by soaking the filament in methanol to obtain the loaded security fiber free of HFIP.
